(19) United States
(12) Patent Application Publication
(10) Pub. No.: US 2002/0134203 A1
(43) Pub. Date: Sep. 26, 2002

(54) Hand-operated multifunction tool

(76) Inventor: Shmuel Dvir, Kfar Vradim (IL)

Correspondence Address: J. RODMAN STEELE, Jr., Akerman, Senterfitt & Eidson, P.A., P.O. Box 3188, West Palm Beach, FL, 33402-3188, US

(21) Appl. No.: 10/074,556

(22) Filed: Feb. 12, 2002

(30) Foreign Application Priority Data
Feb. 12, 2001 (DE) 20102528.0
Feb. 22, 2001 (DE) 20103190.6

(51) Int. Cl. B25B 13/00

(52) U.S. Cl. 81/73

(57) ABSTRACT

The hand tool is used with screws or the like, as well as for performing cutting work, such as deburring, drilling, etc. It comprises a handle like that of a deburring tool and having a polygonal receptacle (24) for the tool insert (26), e.g. a screw bit. The shank is offset in similar manner to a crank and has on its end (80) inserted in the handle (10) by means of the rapid clamping device (62) a sleeve (30) rotating on the shank and which is fixed axially and against rotation in the handle by means of a lateral flattening and an opening using a ball of the rapid clamping device. Correspondingly the handle can receive the crank-like tool (12) operable by a handle crank movement, but also tool shanks placed in non-rotary manner in the handle.

### BACKGROUND OF THE INVENTION

The present invention relates to a hand-operated tool, which is mainly used for carrying out precision mechanical work such as the insertion and removal of screws (screwdrivers, etc.) or the spotfacing and deburring of corresponding holes and bores (deburring tools, etc.).

A tool according to CH 299 807 (Société d'Etudes) comprises a handle, in which is inserted in rotary manner an offset shank. At the head end the shank has a mounting support in which can be engaged as inserts tool heads having the most varied constructions. As a result of the offset design of the shank, these tools can be operated with one hand only for performing the aforementioned functions.

A tool according to U.S. Pat. No. 3,787,972 (Carossino) has a handle, in which is inserted in non-rotary manner a holder fixable in several axial positions by means of a rapid ball clamping device. In the holder is inserted in rotary manner by means of a further rapid ball clamping device a 2-shaped, offset deburring tool, which in crank-like manner by corresponding rotary movements of the handle using one hand, a hole can be made.

In one shank offset axis is located the material-working tip, whilst the other axis forms the handle-side shank part mounted in rotary manner on the handle, so that the machining pressure exerted by the handle is applied displaced by the distance between the two axes. This allows a one-hand material working, e.g. deburring or spotfacing, without it being necessary to grip the handle again during the rotary movement performed.

Such a hand-operated tool can also be gathered from EP 671 233 A1 (Jakob). As in CH 299 807 and U.S. Pat. No. 3,787,972 on the handle is located a tool head with a material-working tip. The tool has a shank, which with respect to the two shank ends has an offset and at the handle side can be held in rotary manner in the handle.

Similar hand-operated tools are known from FR 595,541.

### OBJECTS OF THE INVENTION

The problem of the invention is to improve a hand-operated tool of the aforementioned type, particularly with respect to the mounting of the shank in the handle, in order to permit e.g. an easy replacement of the shank and optionally said handle.

### BRIEF SUMMARY OF THE INVENTION

The tool proposed by the invention provides for the handle to have a cylindrically shaped space for the releasable reception of the offset shank and on the handle-side part of the shank is located a sleeve mounted in rotary manner on said shank and which engages in a substantially positive manner in the space.

The proposed manner of receiving the shank offers a reliable hold thereof in the handle during the rotary movement, particularly in view of the machining pressure acting eccentrically as a result of the offset. In addition, this solution permits an increased ease in the shank movement compared with the known tools, without the shank in any way tilting during rotation.

According to a development, in the space is located a rapid ball clamping device with a preferably rotary mounted ball partly engaging in the internal space and which cooperates with an external flattening on the sleeve provided with a hole and consequently permits a rapid clamping. The handle preferably has a sliding element by means of which the contact pressure of the ball on the recess or depression can be modified from the outside and consequently the insertion and removal of the shank with respect to the handle are facilitated.

Advantageously the tool is usable as a one-hand operation screwdriver, recessing tool, deburring tool, drill, mill or file. As the rotatability of the shank is ensured by the sleeve, even if it is not rotatable in the handle, it is possible to insert in the latter other tools, e.g. the holder according to U.S. Pat. No. 3,787,972 (Carossino), which are admittedly axially adjustable with respect to the handle by means of the rapid ball clamping device, but otherwise are positioned in non-rotary manner.

### BRIEF DESCRIPTION OF THE DRAWINGS

The invention is described in greater detail hereinafter relative to a preferred development and with reference to the attached drawings, wherein show:

FIGS. 1 and 2 A screwing tool in an axial, part sectional view and broken down into a handle (FIG. 1) and a shank (FIG. 2).

FIG. 3 A larger scale, axial section through a sleeve located on the handle-side shank end.

FIG. 4 A cross-section along line III-III in FIG. 3.

### DETAILED DESCRIPTION OF A PREFERRED EMBODIMENT

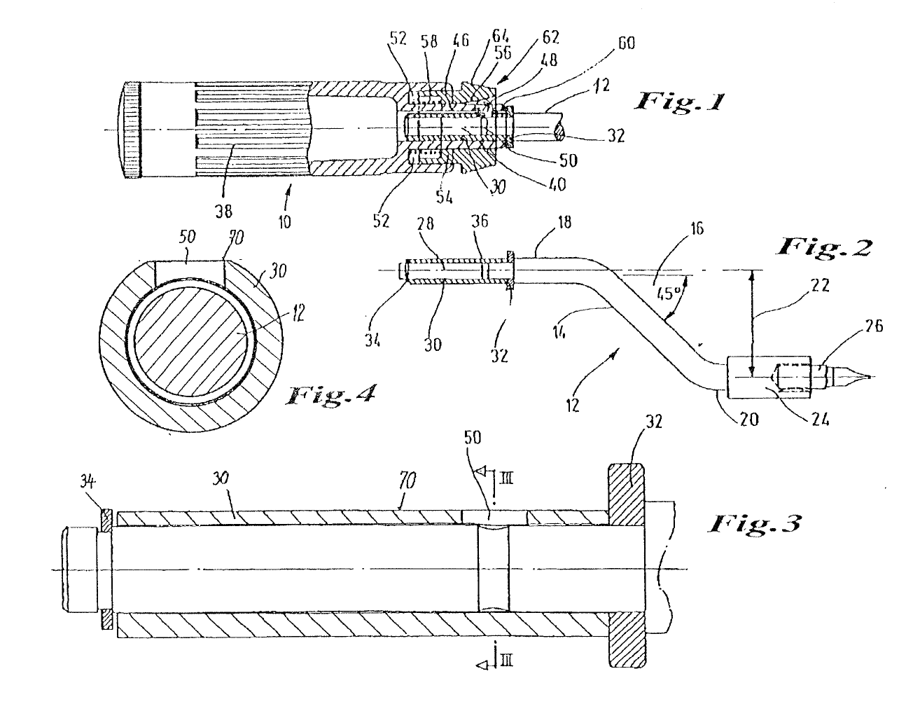

FIGS. 1 and 2 show a screwing tool formed from a handle 10 and a shank 12 in the disassembled state, where the shank 12 is removed from the handle 10. The shank 12 has an offset 14 with an offset angle 16 between 30 and 60°, preferably approximately 45°, the two shank ends 18, 20 being aligned roughly in parallel. It is also possible to see the eccentric spacing 22 between the two axes formed by the shank ends 18, 20. The spacing can be between 20 and 40 mm, preferably approximately 30 mm.

At the right-hand shank end 20 in FIG. 2 is provided an insert holder 24 (tool head) for receiving tool inserts or top parts, e.g. bits and in the embodiment shown a screwing top part 26 for forming a screwdriver. However, different types of other inserts can also be inserted in the insert holder 24. The inserted inserts 26 are held in the insert holder 24 by means of a conventional, not shown magnetic or clamp bolt mounting support, i.e. is secured against axially dropping out over and beyond the polygonal shape of the insert and the holder 24.

The here, left-hand shank end 18 has a sleeve or socket 30 mounted in rotary manner with respect to the shank axis 28, which is held in virtually clearance-free manner in the axial direction at one end by a flange part 32 and at the other end by a circlip 34, i.e. with an axial clearance ensuring rotatability. In the portion 18 the shank 12 has an annular, groove-like recess or groove 36 (or depression). In the embodiment shown, the sleeve 30 has a lateral flattening 70 extending over its entire length and as can in particular be gathered from FIG. 3, in which a hole 50 is provided in the vicinity of the groove 36.

The handle 10 shown in FIG. 1 serves to receive the shank 12 shown in FIG. 2 and in the left-hand area comprises a conventional gripping part 38. The latter corresponds to that of U.S. Pat. No. 3,787,972, to which reference should be made for further details. At the right-hand side the handle 10 has a cylindrical space 40, in the present embodiment a blind hole. This space 40 receives the sleeve and therefore the shank 12 and in the present representation has an already inserted shank 12 with sleeve 30.

For the fixing retention of the sleeve 30 and therefore the shank 12 in the space 40, the handle 10 has a ball 48, made from steel or the like, mounted in an opening through a casing 46 forming the wall of the reception space 40. Following the insertion of the shank 12, in the vicinity of the flattening 70 the ball 48 engages in the hole 50 and optionally through the same into the groove 36 of the sleeve 30 and axially fixes said sleeve 30, whilst also preventing the rotation thereof. In the embodiment shown, the movement clearance of the sleeve 30 is circumferentially restricted. The groove in the shank portion 18 ensures that the ball engaging in the hole 50 does not prevent a rotation of the shank in the sleeve.

By means of an annular acting member 54, which is axially movable and inserted in a corresponding annular groove 52 of the handle and whose inner bore in the vicinity of the ball 48 forms an inclined or conically outwardly opening blocking surface 56, a contact pressure dependent on the position of the actuating member 54 is exerted on the ball 48. The actuating member 54 is pretensioned by means of a spiral spring 58, so that the contact pressure blocking the ball in the handle wall surrounding the space 40 is automatically exerted on the ball 48. Thus, without any further action the inserted shank 12 “snaps” into the handle 10. During the insertion of the shank 12 into the handle 10, the flange part 32 simultaneously serves as a path limiting means, because after “snapping in” it engages with the collar 60 of the blind hole 40. The flattening 70 facilitates the insertion of the sleeve 30 into the reception space 40 and prevents the complete rotatability of the sleeve therein, but guides the latter in such a way that it is automatically guided with the opening or hole 50 to the ball 48, which then drops into it.

The actuating member 54 movable in the manner of an annular slider has in at least one outwardly accessible area 62 for the improvement of handling a surface-structured finger support face 64 at right angles to the movement direction of the actuating member 54 and which is used for the removal of the shank 12 from the handle 10 and for this purpose only has to be moved towards the handle 10, so that the blocking of the ball 48 is set aside, the latter is moved radially outwards by the axially outwardly drawn sleeve and the shank 12 can be easily removed from the handle 10.

The described reception of the shank 12 permits an easy, rapid bringing together and separation of the shank 12 with respect to the handle 10 and can be looked upon as a rapid closure.

The interior of the handle is advantageously joined to the reception space 40 and is used on the one hand for receiving a longer tool shank and on the other as a magazine for tool inserts 26 and the like.

The very easy rotatability of the offset shank 12 in the handle 10 necessary for the satisfactory operation of the tool is also ensured in that the shank 12 can rotate with slight friction at least within the sleeve 30.

FIG. 4 shows on a larger scale an axial section through the sleeve 30 or socket shown in FIGS. 1a and 1b. It is possible to see the axially clearance-free, fixing mounting of the sleeve 30 by means of the flange part 32 and circlip 34. It also illustrates the positioning of the hole 50 on the flattening 70 of the outside of sleeve 30.

For using the tool a tool head which is a function of the particular application, such as a bit 26 (e.g. screwing insert) is inserted in the insert holder usually provided with a hexagonal recess and then the tool head is magnetically or by ball spring catch retained in the insert holder. The tool head is then engaged on the workpiece, in the case of a screwdriver on the screw, and the handle is turned with one hand about the axis thereof. As a result the offset axis of the shank rotates around the eccentric radius and brings about a corresponding rotation of the tool head and in the case of a screwdriver a corresponding rotation of the screw. In the case of a deburring or recessing tool a workpiece, on whose bore the tool is engaged, is machined.

In all cases the tool is centred on the workpiece, so that the handle crank movement can be performed. Due to the fact that the rotatability of the shank is ensured by the rotatability of the sleeve on the shank end 18, it is not only possible to insert tools to be positioned in non-rotary manner in the handle 10, but also conventional handles, as have been manufactured in large numbers by the applicant (assignee) of U.S. Pat. No. 3,787,972, for the shank 12 according to the invention.

1. Hand-operated tool comprising:
a handle (10) and
a shank (12) held in rotary manner on the handle (10) and which has a first end portion (20) with a first axis and a second end portion (18) with a second axis,
where on the first end portion (20) is provided a receptacle (24) for the releasable insertion of a tool insert (26) and on the second end portion (18) a sleeve (30) rotatable about the second axis, but fixed in the axial position on said second end portion (18),
the first and second axes are parallel to one another, but mutually displaced by a spacing (22) and
the first and second end portions are interconnected by an intermediate portion (14) of the shank (12) forming an offset and
the sleeve is insertable in a reception space (40) in the handle (10) and can be fixed therein by means of a rapid clamping device,
whereby the shank is rotatable in the sleeve fixed to the handle by means of one hand of the user gripping the handle in crank-like manner about the tool insert centring the shank during its rotation.

2. Tool according to claim 1, wherein the sleeve (30) is retained in rotatable and substantially clearance-free manner on the shank (12) by means of a circlip (34) and a flange part (32).

3. Tool according to claim 1, wherein the rapid clamping device has a ball (48) located in the handle (10) and partly engaging in the reception space (40) and the sleeve (30) has a non-circular cylindrical outer face and can be axially fixed in non-rotary manner in the reception space.

4. Tool according to claim 3, wherein the sleeve (30) has a flattening (70) on the otherwise circular cylindrical outer face.

5. Tool according to claim 3, wherein the sleeve (30) has an opening (50) passing through the outer face.

6. Tool according to claim 5, wherein the second end portion (18) of the shank has a circumferential groove in the vicinity of the opening (50).

7. Tool according to claim 3, wherein the handle (10) has a wall surrounding the space (40) with an opening in which the ball (48) is located and where the wall is surrounded by an actuating member (54), which in the vicinity of the ball (48) has a blocking surface for a radial movement of the ball and is movable counter to the tension of a spring from an axial blocking position into a release position for the ball.

8. Tool according to claim 7, wherein the actuating member (54) is formed by a cylindrical ring element with an externally shaped gripping face (64).

9. Tool according to claim 1, wherein the intermediate portion (14) of the shank (12) is under an angle between 30 and 60° with respect to the first and second axes and the spacing between the two substantially parallel axes is between 20 and 40 mm.

10. Tool according to claim 1, wherein the tool insert (26) is from a group of machining tools containing the following:
a screw bit,
a recessing tool,
a deburring tool,
a drill,
a mill,
a file.

11. Tool according to claim 1, wherein the receptacle (24) for the releasable insertion of a tool insert (26) contains a polygonal recess and a retaining device cooperating with the tool insert (26) to prevent axial movement thereof.
